(19) United States
(12) Patent Application Publication
(10) Pub. No.: US 2007/0002730 A1
(43) Pub. Date: Jan. 4, 2007

(54) Computer platform system program remote recovery control method and system

(75) Inventors: Ying-Chih Lu, Taipei (TW); Wen-Chian Chao, Taipei (TW)

Correspondence Address: EDWARDS & ANGELL, LLP, P.O. BOX 55874, BOSTON, MA, 02205, US

(73) Assignee: Inventec Corporation, Taipei (TW)

(21) Appl. No.: 11/209,552

(22) Filed: Aug. 22, 2005

(30) Foreign Application Priority Data
Jun. 29, 2005 (TW) 094121808

(51) Int. Cl. H04J 1/16

(52) U.S. Cl. 370/216

(57) ABSTRACT

A computer platform system program remote recovery control method and system is proposed, which is designed for use with a network system for providing a network-linked computer platform, such as a server, with a remote recovery control function, which is characterized by the utilization of a specific network communication protocol for a remote network workstation to send a copy of system image and a set of associated recovery control commands in compliant with a specific interface protocol that is utilized on the server for the server to execute these recovery control commands to reload the remotely-downloaded system image in a failed system program in the local server. This feature allows network management work to be more efficient and responsive than prior art.

### BACKGROUND OF THE INVENTION

1. Field of the Invention

This invention relates to computer network technology, and more particularly, to a computer platform system program remote recovery control method and system which is designed for use in conjunction with a network system linked to a computer platform, such as a network server, for providing the server with a real-time and fully-automatic remote recovery control capability that allows a failed BIOS module in the server to be recovered via a remote network workstation.

2. Description of Related Art

A network server is a network-linked computer platform that is permanently linked to a network system, such as Internet, an intranet system, an extranet system, or a LAN (Local Area Network) system, for providing network-based data services to client workstations that are also linked to the network system.

BIOS (Basic Input/Output System) is a widely used system program on network servers for providing an interface between the operating system and the various hardware components (including peripheral devices) installed on the server for the purpose of allowing the server to control the operations of these hardware components and peripheral devices through the operating system. In practice, BIOS programs are typically stored in a non-volatile programmable memory, such as flash memory. The use of flash memory for storing BIOS program allows network management personnel to conveniently upgrade or reload new BIOS program in the flash memory.

During operation of the server, it is likely that a failure would occasionally occur to the BIOS module. In this case, the server will be unable to boot up or continue to operate normally. Under this condition, the local network management personnel is required to perform a recovery procedure on the failed BIOS module, in which a system image of the BIOS program is reloaded into the flash memory so as to resume the server back to normal operation.

Presently, one method for recovering a failed BIOS module is performed by local network management personnel by first manually connecting a system image storage unit, such as floppy disk drive, USB portable flash memory module, or CD/DVD drive, to the server; then manually flipping hardware jumpers into a specified configuration so as to set the server to a BIOS recovery mode; and finally downloading a copy of BIOS system image from the storage unit to the flash memory. This procedure allows the failed BIOS program in the flash memory to be recovered, so that the server can be resumed to normal operation. However, this manually-performed recovery procedure is undoubtedly quite tedious, laborious, and time-consuming.

Moreover, in the application of enterprise network systems, it is a common practice to cluster all servers owned by the enterprise at a single location, and all these servers are monitored and managed by network management personnel at remote office locations with network workstations linked via a network to the servers. Due to this reason, in the event of a failure to the BIOS module on a certain server, the remotely-located network management personnel can be notified of this situation by his/her network workstations linked to the failed server. However, in order to recover the failed BIOS program, the network management personnel nevertheless need to personally contact the local personnel, for example by phone, to ask the local personal to manually perform the above-mentioned recovery procedure. This practice is undoubtedly quite tedious and time-consuming, making the network management quite inefficient and irresponsive.

### SUMMARY OF THE INVENTION

It is therefore an objective of this invention to provide a computer platform system program remote recovery control method and system which allows a server with a failed BIOS module to be recovered automatically through remote network control via a remote network workstation without requiring local personnel to intervene, so as to make the network management work more efficient and responsive.

The computer platform system program remote recovery control method and system according to the invention is designed for use in conjunction with a network system linked to a computer platform, such as a network server, for providing the server with a real-time and fully-automatic remote recovery control capability that allows a failed BIOS module in the server to be recovered via a remote network workstation.

The computer platform system program remote recovery control method according to the invention comprises: (1) on the remote network workstation, prestoring a system image for the system program module on the local computer platform; (2) on the local computer platform, monitoring the condition of the system program module to check whether a failure occurs to the system program module; and if YES, issuing a system program failure notification message, and transferring the system program failure notification message via the network system to the remote network workstation; (3) on the remote network workstation, responding to the system program failure notification message received via the network system from the local computer platform by generating a system image downloading enable message; (4) on the remote network workstation, responding to the system image downloading enable message by retrieving a copy of system image and meanwhile generating a set of recovery control commands in compliant with a specific interface protocol that is utilized on the computer platform, and transmitting the retrieved system image together with the recovery control commands via the network system to the local computer platform; (5) on the local computer platform, receiving the system image and recovery control commands via the network system from the remote network workstation, and processing the recovery control commands to thereby reload the received system image into the system program module so as to recover the failed system program in the system program module.

In terms of architecture, the computer platform system program remote recovery control system according to the invention is based on a distributed architecture comprising: (A) a remote unit; and (B) a local unit; wherein the remote unit is installed on the remote network workstation, and which includes: (A0) a remote side network communication module, which is capable of linking the network workstation via the network system to the computer platform for the network workstation to communicate with the computer platform via the network system; (A1) a system program failure condition responding module, which is capable of responding to a system program failure notification message received by the remote side network communication module via the network system from the computer platform by generating a system image downloading enable message; and (A2) a remote system image downloading module, which is linked to a system image storage module where a system image for the system program module in the computer platform is stored, and which is capable of responding to the system image downloading enable message from the system program failure condition responding module by retrieving a copy of system image from the system image storage module and meanwhile generating a set of recovery control commands in compliant with a specific interface protocol that is utilized on the computer platform, and then capable of transmitting the retrieved system image together with the recovery control commands by means of the remote side network communication module and via the network system to the computer platform; and wherein the local unit is installed on the computer platform, and which includes: (B0) a local side network communication module, which is installed on the computer platform, and which is capable of linking the computer platform via the network system to the network workstation for the computer platform to communicate with the network workstation via the network system; (B1) a system program failure condition monitoring module, which is capable of monitoring the condition of the system program module to check whether a failure occurs to the system program module; and if YES, capable of issuing a system program failure notification message and activating the local side network communication module to transfer the system program failure notification message via the network system to the remote network workstation; and (B2) a system image reloading module, which is capable of processing the recovery control commands received by the local side network communication module via the network system from the remote network workstation to thereby reload the received system image into the system program module so as to recover the failed system program in the system program module.

The computer platform system program remote recovery control method and system according to the invention is characterized by the utilization of a specific network communication protocol, such as TCP/IP or UDP/IP, for a remote network workstation to send a copy of BIOS system image and a set of associated recovery control commands in compliant with a specific interface protocol that is utilized on the server, such as IPMI-compliant commands, for the IPMI-equipped server to execute these IPMI-compliant recovery control commands to recover a failed BIOS module in the local server. This feature allows a local server having a failed BIOS module to be automatically recovered through remote network control, without requiring local personnel to intervene, and therefore allows the network management work to be more efficient and responsive than prior art.

### BRIEF DESCRIPTION OF DRAWINGS

The invention can be more fully understood by reading the following detailed description of the preferred embodiments, with reference made to the accompanying drawings, wherein:

FIG. 1 is a schematic diagram showing the application and distributed system architecture of the computer platform system program remote recovery control system of the invention;

FIG. 2 is a schematic diagram showing the object-oriented component model of the internal architecture of a remote unit utilized by the computer platform system program remote recovery control system of the invention; and

FIG. 3 is a schematic diagram showing the object-oriented component model of the internal architecture of a local unit utilized by the computer platform system program remote recovery control system of the invention.

### DETAILED DESCRIPTION OF PREFERRED EMBODIMENTS

The computer platform system program remote recovery control method and system according to the invention is disclosed in full details by way of preferred embodiments in the following with reference to the accompanying drawings.

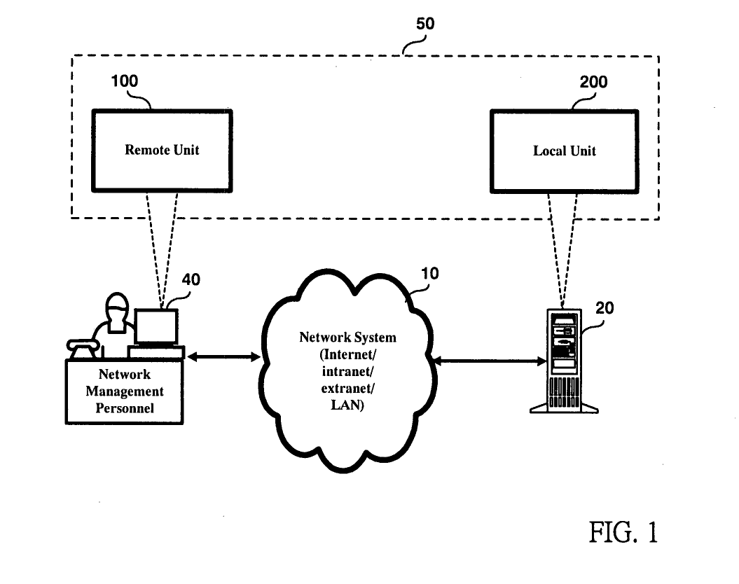

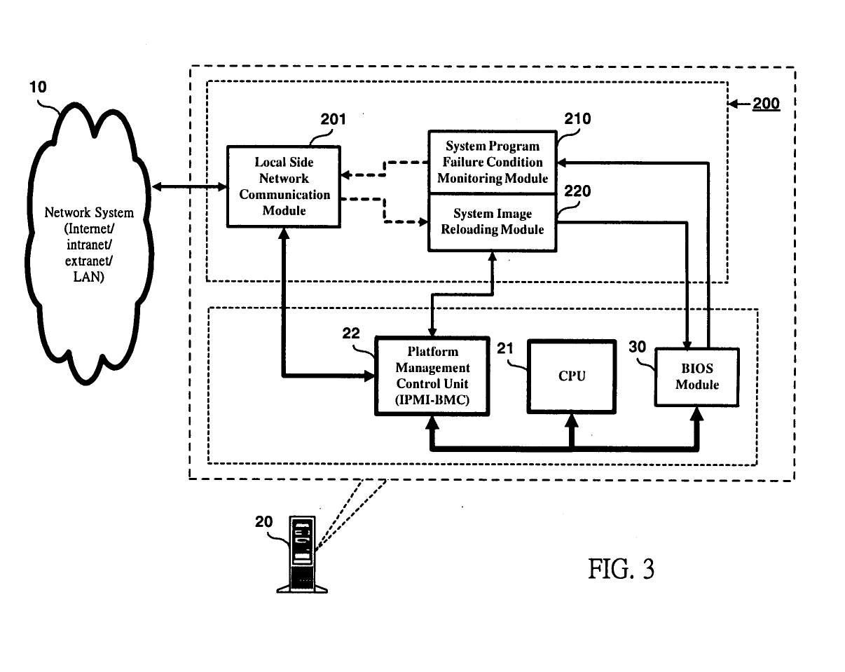

FIG. 1 is a schematic diagram showing the application and distributed system architecture of the computer platform system program remote recovery control system according to the invention (as the part enclosed in the dotted box indicated by the reference numeral 50). As shown, the computer platform system program remote recovery control system of the invention 50 is designed for use in a distributed manner for installation on a remote network workstation 40 and a local computer platform, such as a server 20, both of which are linked to a network system 10, such as Internet, an intranet system, an extranet system, a LAN (Local Area Network) system, or a combination thereof. As shown in FIG. 3, the local server 20 should be installed with a CPU (Central Processing Unit) 21, a platform management control unit 22, such as a BMC (Baseboard Management Controller) that is based on the standard IPMI (Intelligent Platform Management Interface) protocol, and further installed with at least one system program module, such as a BIOS module 30. In the embodiment of FIG. 1, for example, only one server 20 is illustrated for demonstrative purpose; but in practice, the network workstation 40 can be configured to perform a remote recovery control procedure concurrently on two or more servers.

Under normal conditions, the server 20 operates on the BIOS module 30 for system input/output functions. In the event of a failure to the BIOS module 30, the remote recovery control system of the invention 50 can be automatically activated to download a BIOS system image from the network workstation 40 via the network system 10 to the server 20 for the purpose of recovering the BIOS module 30 so to as resume the server 20 back to normal operation.

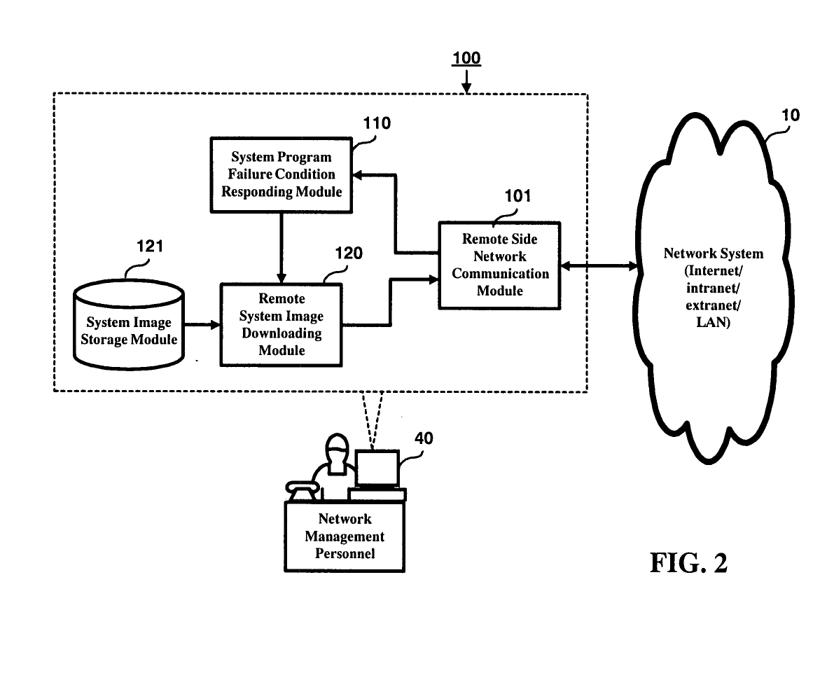

As shown in FIG. 1, in architecture, the computer platform system program remote recovery control system of the invention 50 comprises two distributed units: (A) a remote unit 100; and (B) a local unit 200; wherein as shown in FIG. 2, the remote unit 100 is installed on the remote network workstation 40 and whose internal architecture includes: (A0) a remote side network communication module 101; (A1) a system program failure condition responding module 110; and (A2) a remote system image downloading module 120 and a system image storage module 121; and wherein, as shown in FIG. 3, the local unit 200 is installed on the server 20 and whose internal architecture includes: (B0) a local side network communication module 201; (B1) a system program failure condition monitoring module 210; and (B2) a system image reloading module 220.

Firstly, the respective attributes and functions of the constituent modules 101, 110, 120 of the remote unit 100 installed on the remote network workstation 40 are described in details in the following. The remote side network communication module 101 is installed on the remote network workstation 40, and which is used for linking the network workstation 40 via the network system 10 to the server 20 for the network workstation 40 to communicate with the server 20 via the network system 10. In practical implementation, for example, this remote side network communication module 101 is based on an NIC (Network Interface Controller) that employs TCP/IP (Transmission Control Protocol/Internet Protocol) or UDP/IP (User Datagram Protocol/Internet Protocol) for network data transmission, and which utilizes the IP (Internet Protocol) address of the server 20 to link via the network system 10 to the server 20.

The system program failure condition responding module 110 is designed for listening to a system program failure notification message received by the remote side network communication module 101 via the network system 10 from the server 20 when a failure occurs to the BIOS module 30 in the server 20, and responding to the system program failure notification message by issuing a system image downloading enable message to the remote system image downloading module 120.

The remote system image downloading module 120 is linked to a system image storage module 121 where a system image for the BIOS program module 30 in the server 20 is stored, and which is capable of responding to the system image downloading enable message from the system program failure condition responding module 110 by retrieving a copy of the BIOS system image from the system image storage module 121 and meanwhile generating a set of recovery control commands in compliant with a specific interface protocol that is utilized on the computer platform. The remote system image downloading module 120 is then capable of transmitting the binary data stream of the retrieved system image and the recovery control commands by means of the remote side network communication module 101 and via the network system 10 to the server 20. In the case that the platform management control unit 22 on the server 20 is an IPMI-compliant BMC unit, this remote system image downloading module 120 is configured to send the recovery control commands in IPMI-compliant formats. In practice, for example, the BIOS system image stored in the system image storage module 121 can be preloaded by network management personnel into the network workstation 40, or alternatively remotely uploaded via the network system 10 from the local server 20 by first making a system image out of the existing BIOS program in the BIOS module 30 and then transferring the BIOS system image via the network system 10 to the network workstation 40 where the uploaded BIOS system image is stored into the system image storage module 121 to serve as a remote backup in the event of a failure to the BIOS module 30.

Next, the respective attributes and functions of the constituent modules 201, 210, 220 of the local unit 200 installed on the server 20 are described in details in the following.

The local side network communication module 201 is installed on the server 20, and which is used for linking the server 20 via the network system 10 to the network workstation 40 for the server 20 to communicate with the network workstation 40 via the network system 10. This local side network communication module 201 should be compliant in network communication protocol with the remote side network communication module 101 installed on the network workstation 40. In practical implementation, for example, the local side network communication module 201 is also based on an NIC unit that employs TCP/IP or UDP/IP network communication protocol, and which utilizes the IP address of the network workstation 40 for linking via the network system 10 to the network workstation 40. In actual operation, this local side network communication module 201 is capable of receiving TCP/IP or UDP/IP data packets via the network system 10 from the remote network workstation 40 and demodulate these TCP/IP or UDP/IP data packets to retrieve the transmitted BIOS system image and IPMI-compliant recovery control commands, and then transfer the IPMI-compliant recovery control commands via the IPMI-BMC platform management control unit 22 to the system image reloading module 220.

The system program failure condition monitoring module 210 is capable of monitoring the condition of the system program module 30 to check whether a failure occurs to the system program module 30. If a failure occurs, this system program failure condition monitoring module 210 is capable of promptly issuing a system program failure notification message and activating the local side network communication module 201 to transfer this system program failure notification message via the network system 10 to the remote network workstation 40. In practical implementation, this system program failure condition monitoring module 210 is controlled by the IPMI-BMC platform management control unit 22 and, in the event of a failure to the BIOS module 30, capable of issuing a “Checksum Bad” message in IPMI format to the IPMI-BMC platform management control unit 22 and meanwhile issuing a “LAN Alert” message also in IPMI format via the network system 10 to the remote network workstation 40.

The system image reloading module 220 is designed to be controlled by the IPMI-BMC platform management control unit 22 for processing the IPMI-compliant recovery control commands received by the local side network communication module 201 via the network system 10 from the remote network workstation 40 to thereby reload the received BIOS system image into the BIOS module 30, for the purpose of recovering the operation of the BIOS module 30 in the event of a failure has occurred to the BIOS module 30 so as to resume the server 20 back to normal operation.

In the following description of an example of a practical application of the invention, it is assumed that a failure occurs to the BIOS module 30 in the server 20, which causes the computer platform system program remote recovery control system of the invention 50 to be activated to automatically recover the failed program code in the BIOS module 30.

Referring to FIG. 1 through FIG. 3 together, in the event of a failure to the BIOS module 30 on the local server 20, the system program failure condition monitoring module 210 in the local unit 200 installed on the local server 20 will detect this condition and responsively issue and transfer a system program failure notification message by means of the local side network communication module 201 and via the network system 10 to the remote network workstation 40.

On the remote side, the remote side network communication module 101 in the remote unit 100 installed on the network workstation 40 will receive the system program failure notification message via the network system 10 from the server 20, and then transfer this system program failure notification message to the system program failure condition responding module 110. In response, the system program failure condition responding module 110 issues a system image downloading enable message to the remote system image downloading module 120, thereby activating the remote system image downloading module 120 to respond by retrieving a copy of BIOS system image from the system image storage module 121 and meanwhile generating a set of IPMI-compliant recovery control commands. The binary data stream of the retrieved BIOS system image together with the associated IPMI-compliant recovery control commands are then formatted by the remote side network communication module 101 into TCP/IP or UDP/IP data packets for network transmission through TCP/IP or UDP/IP over the network system 10 to the local server 20.

On the local side, the local side network communication module 201 on the local server 20 will receive the TCP/IP or UDP/IP data packets transmitted from the network workstation 40 via the network system 10, and then demodulate the TCP/IP or UDP/IP data packets to retrieve the original data of the BIOS system image and the IPMI-compliant recovery control commands. The local side network communication module 201 then transfers the BIOS system image and the IPMI-compliant recovery control commands to the system image reloading module 220 which is controlled by the IPMI-BMC platform management control unit 22 to process these IPMI-compliant recovery control commands to thereby reload the received BIOS system image into the BIOS module 30, for the purpose of recovering the failed program code in the BIOS module 30.

In conclusion, the invention provides a computer platform system program remote recovery control method and system which is designed for use with a network system for providing a local server with a remote recovery control capability, which is characterized by the utilization of a specific network communication protocol, such as TCP/IP or UDP/IP, for a remote network workstation to send a copy of BIOS system image and a set of associated recovery control commands in compliant with a specific interface protocol that is utilized on the server, such as IPMI-compliant commands, for the IPMI-equipped server to execute these IPMI-compliant recovery control commands to recover a failed BIOS module in the local server. This feature allows a local server having a failed BIOS module to be automatically recovered through remote network control, without requiring local personnel to intervene, and therefore allows the network management work to be more efficient and responsive than prior art. The invention is therefore more advantageous to use than prior art.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A computer platform system program remote recovery control method for use on a network system linked to a local computer platform that is equipped with a system program module for providing the computer platform with a remote recovery control capability that allows a remote network workstation to remotely recover the system program module in the event of a failure to the system program module;
the computer platform system program remote recovery control method comprising:
on the remote network workstation, prestoring a system image for the system program module on the local computer platform;
on the local computer platform, monitoring the condition of the system program module to check whether a failure occurs to the system program module; and if YES, issuing a system program failure notification message;
on the local computer platform, transferring the system program failure notification message via the network system to the remote network workstation;
on the remote network workstation, responding to the system program failure notification message received via the network system from the local computer platform by generating a system image downloading enable message;
on the remote network workstation, responding to the system image downloading enable message by retrieving a copy of system image and meanwhile generating a set of recovery control commands in compliant with a specific interface protocol that is utilized on the computer platform;
on the remote network workstation, transmitting the retrieved system image together with the recovery control commands via the network system to the local computer platform;
on the local computer platform, receiving the system image and recovery control commands via the network system from the remote network workstation; and
on the local computer platform, processing the recovery control commands to thereby reload the received system image into the system program module so as to recover the failed system program in the system program module.

2. The computer platform system program remote recovery control method of claim 1, wherein the computer platform is a network server.

3. The computer platform system program remote recovery control method of claim 1, wherein the network system includes the Internet.

4. The computer platform system program remote recovery control method of claim 1, wherein the network system includes an extranet system.

5. The computer platform system program remote recovery control method of claim 1, wherein the network system includes an intranet system.

6. The computer platform system program remote recovery control method of claim 1, wherein the network system includes a LAN (Local Area Network) system.

7. The computer platform system program remote recovery control method of claim 1, wherein the recovery control commands generated by the remote system image downloading module are IPMI (Intelligent Platform Management Interface) compliant commands.

8. The computer platform system program remote recovery control method of claim 1, wherein the remote side network communication module and the local side network communication module communicate with each other via TCP/IP (Transmission Control Protocol/Internet Protocol).

9. The computer platform system program remote recovery control method of claim 1, wherein the remote side network communication module and the local side network communication module communicate with each other via UDP/IP (User Datagram Protocol/Internet Protocol).

10. A computer platform system program remote recovery control system for use with a network system linked to a computer platform that is equipped with a system program module for providing the computer platform with a remote recovery control capability that allows a remote network workstation to remotely control the recovery of the system program module in the event of a failure to the system program module;
the computer platform system program remote recovery control system is based on a distributed architecture comprising a remote unit and a local unit;
wherein
the remote unit is installed on the remote network workstation, and which includes:
a remote side network communication module, which is capable of linking the network workstation via the network system to the computer platform for the network workstation to communicate with the computer platform via the network system;
a system program failure condition responding module, which is capable of responding to a system program failure notification message received by the remote side network communication module via the network system from the computer platform by generating a system image downloading enable message; and
a remote system image downloading module, which is linked to a system image storage module where a system image for the system program module in the computer platform is stored, and which is capable of responding to the system image downloading enable message from the system program failure condition responding module by retrieving a copy of system image from the system image storage module and meanwhile generating a set of recovery control commands in compliant with a specific interface protocol that is utilized on the computer platform, and then capable of transmitting the retrieved system image together with the recovery control commands by means of the remote side network communication module and via the network system to the computer platform;
and wherein
the local unit is installed on the computer platform, and which includes:
a local side network communication module, which is installed on the computer platform, and which is capable of linking the computer platform via the network system to the network workstation for the computer platform to communicate with the network workstation via the network system;
a system program failure condition monitoring module, which is capable of monitoring the condition of the system program module to check whether a failure occurs to the system program module; and if YES, capable of issuing a system program failure notification message and activating the local side network communication module to transfer the system program failure notification message via the network system to the remote network workstation; and
a system image reloading module, which is capable of processing the recovery control commands received by the local side network communication module via the network system from the remote network workstation to thereby reload the received system image into the system program module so as to recover the failed system program in the system program module.

11. The computer platform system program remote recovery control system of claim 10, wherein the computer platform is a network server.

12. The computer platform system program remote recovery control system of claim 10, wherein the network system includes Internet.

13. The computer platform system program remote recovery control system of claim 10, wherein the network system includes an extranet system.

14. The computer platform system program remote recovery control system of claim 10, wherein the network system includes an intranet system.

15. The computer platform system program remote recovery control system of claim 10, wherein the network system includes a LAN (Local Area Network) system.

16. The computer platform system program remote recovery control system of claim 10, wherein the recovery control commands generated by the remote system image downloading module are IPMI (Intelligent Platform Management Interface) compliant commands.

17. The computer platform system program remote recovery control system of claim 10, wherein the remote side network communication module and the local side network communication module communicate with each other via TCP/IP (Transmission Control Protocol/Internet Protocol).

18. The computer platform system program remote recovery control system of claim 10, wherein the remote side network communication module and the local side network communication module communicate with each other via UDP/IP (User Datagram Protocol/Internet Protocol).
